(19) United States
(12) Patent Application Publication
(10) Pub. No.: US 2006/0004830 A1
(43) Pub. Date: Jan. 5, 2006

(54) Agent-less systems, methods and computer program products for managing a plurality of remotely located data storage systems

(76) Inventors: Brian Matthew Lora, Raleigh, NC (US); Frank Brick, Chapel Hill, NC (US); Steven Horan, Cary, NC (US); Dan Lewis, The Woodlands, TX (US); James Olevano, Holly Springs, NC (US); Randy Whitehead, Cary, NC (US)

Correspondence Address: MYERS BIGEL SIBLEY & SAJOVEC, PO BOX 37428, RALEIGH, NC, 27627, US

(21) Appl. No.: 10/862,712

(22) Filed: Jun. 7, 2004

(51) Int. Cl. G06F 17/00

(52) U.S. Cl. 707/102

(57) ABSTRACT

Agent-less data storage management systems, methods and computer program products are provided and include a central data repository, a raw data processor (RDP), a management appliance, and problem identification logic. The RDP collects raw, unformatted metadata directly from remote data storage systems, transforms the collected metadata to a standardized format, and stores the transformed metadata in the central data repository. The RDP collects metadata from remote data storage systems without the use of agents executing at each remote data storage system. The management appliance implements corrective action and configuration changes at each data storage system, and makes configuration changes at each data storage system without the use of agents executing at each remote data storage system. Problem identification logic reviews metadata collected by the RDP, identifies problems at remote data storage systems that require resolution, and initiates corrective action.

### FIELD OF THE INVENTION

The present invention relates generally to data storage and, more particularly, to management of data storage systems.

### BACKGROUND OF THE INVENTION

The evolution of information technology into the central nervous system of the modern enterprise has dramatically changed the amount of digital information generated and stored by today's business ventures. Personal productivity applications such as spreadsheets, word processors, presentation software, and personal database programs have driven personal computers (PCs) to include gigabytes of storage. E-mail has become a core business communication tool and the worldwide e-mailbox count is estimated to exceed one billion. Both e-mail volume and e-mail attachment size and volume have increased dramatically. At the same time department and workgroup collaborative applications combined with Web and customer-facing have resulted in the generation of terabytes of data. The full impact of multimedia digitization of books, audio, and video is yet to be realized.

As a result, the mission critical nature of an enterprise's digital information has increased. Data is now viewed as the life blood of the enterprise since any disruption in electronic data flow can destroy an enterprises ability to function. Current industry estimates suggest an enterprise that experiences a disruption in data access lasting more than 10 days may never fully recover financially, and that 50% of those may be out of business within 5 years. Therefore, data storage is now viewed as a critical business function and maintaining its availability, integrity, and security is a matter of survival for enterprises today.

This new position of electronic data as a core mission critical asset is creating new challenges in information and data storage management. New innovations in storage management have enabled the replacement of traditional direct-attached storage systems with centralized storage networks. In a centralized storage network environment, documents and other data are stored in a central file system owned, controlled, or directly managed by the enterprise, or by a contracted outsourcing organization. A storage management system is accessed via a private network such as a local area network (LAN) or a restricted subset of public network technology such as an Intranet or a virtual private network (VPN). Typical enterprise storage management systems provide techniques to index documents by document categories and keywords, plain-language names, document numbers and/or entered attributes. Index based searching capabilities are typically provided, also.

Centralized storage networks can allow storage devices to be decoupled from specific hardware and managed as a centralized resource pool. Virtually any server can have access to any and all of the storage capacity, allowing available storage to be allocated to the point of need. Both scalability and flexibility are increased, and growing needs for storage can be met by adding more capacity to a storage pool instead of individual point servers.

However, while data storage networks are enabling improved efficiencies and scalabilities of storage hardware, the complexities of managing storage networks has increased dramatically. Problems that arise can be extremely complex and difficult to solve, and typically require an enterprise to have access to highly skilled and specialized technicians. As a result, data storage system administration can represent a substantial portion of an enterprise's information technology (IT) budget. Moreover, data storage system problems and disruptions may severely impact business continuity.

As a result, many enterprises are viewing data storage management skills as a required core competency. However, they are finding it difficult and expensive to train, maintain, and retain in-house expertise. The infrequency of problems within any one firm makes it difficult for one firm to maintain freshness in the problem resolution skills of an internally captive staff. Reducing costs by assigning these individuals to other tasks further dilutes skill focus and can cause employee retention problems. The particular selection of vendor tools and products made by any one firm may also limit internal staffing exposure to new and emerging trends.

Vendors in the data storage management industry are pursuing proprietary approaches as a competitive tool to lock customers into vendor products. There currently are no fully integrated tools that take a multi-vendor and system wide perspective. Firms currently use a variety of multi-vendor tools and techniques to manage and troubleshoot their data storage systems. Unfortunately, this can add cost and complexity to data storage management. Accordingly, there is a need for improved, lower cost ways of managing data storage management systems.

In recent years, Internet-enabled file storage providers have begun to provide remote file storage for businesses or individuals that cannot afford enterprise data management solutions. At best, these companies take the functionality of personal computer file systems, such as Microsoft's Windows Explorer, to the Internet. Their focus is on the individual consumer and small project teams with no consideration of an organization's need to securely manage large volumes or information in customized manners. As data are transmitted over a public data network (e.g., the Internet), security of the data can be compromised. The data can be intercepted, read, or tampered with in such a manner as to reduce the value of the data. Data residing on hosted Internet-provided file storage systems can be compromised by unauthorized access to that data by personnel nominally responsible for only managing and maintaining the storage of the data.

Accordingly, there is a need for secure data storage management that is more affordable for small and medium-sized enterprises.

### SUMMARY OF THE INVENTION

In view of the above, agent-less data storage management systems, methods and computer program products for managing a plurality of remotely located data storage systems are provided. According to an embodiment of the present invention, agent-less data storage management systems, include a central data repository, a raw data processor (RDP), a management appliance, and problem identification logic operably associated with the central data repository, RDP and management appliance. The RDP collects raw, unformatted metadata directly from each respective remote data storage system, transforms the collected metadata to a standardized format, and stores the transformed metadata in the central data repository. The RDP includes a dynamically modifiable interface for use in transforming raw, unformatted metadata to a standardized format. This interface allows users to quickly and easily modify the format that collected metadata is transformed into.

According to embodiments of the present invention, the RDP archives collected metadata prior to transforming the collected metadata to a standardized format. The RDP may also consolidate and/or filter collected metadata before storing the collected metadata in the central data repository.

The RDP collects metadata from each remote data storage system without the use of agents executing at each remote data storage system. The management appliance implements corrective action and configuration changes at each data storage system, and makes configuration changes at each data storage system without the use of agents executing at each remote data storage system. The problem identification logic reviews metadata collected by the RDP, identifies problems at remote data storage systems that require resolution, and initiates corrective action at a respective remote data storage system in response to identifying a problem. Corrective action may be initiated at a respective remote data storage system via the management appliance. Alternatively, a third party may be notified that corrective action is required. According to embodiments of the present invention, the problem identification logic includes pattern recognition logic that identifies patterns known to precede data storage problems at remote data storage systems.

Agent-less data storage management systems, according to embodiments of the present invention, include a plurality of web portals, each associated with a respective remote data storage system and each in communication with the central data repository. Each web portal provides user access to information about a respective one of the remote data storage systems. Each web portal also allows user control and configuration of data storage devices at a remotely located data storage

system.

Agent-less data storage management systems, according to embodiments of the present invention, may include a data mining and reporting system that allows users to mine metadata stored in the central data repository and to prepare reports utilizing mined data.

Agent-less data storage management systems, methods and computer program products, according to embodiments of the present invention, are advantageous over conventional agent-based data storage management systems because the installation and maintenance of agents at remote data storage systems is eliminated. With conventional agent-based data management systems, updates to agents are required for hardware and technology changes at a remote data site. By eliminating the need for agents, embodiments of the present invention provide much needed time and cost savings.

Embodiments of the present invention can alleviate the need for captive in-house data storage management expertise, and can expand the market reach of storage network technologies to smaller firms. Embodiments of the present invention allow multiple independent customers to efficiently utilize the knowledge, skills, and services of a shared pool of data storage experts without relinquishing control of their data systems. The application of these techniques can result in a higher quality of service and lower management cost.

### BRIEF DESCRIPTION OF THE DRAWINGS

FIG. 1 is a block diagram that illustrates an agent-less data storage management system for managing a plurality of remotely located, independent customer data storage systems, according to embodiments of the present invention.

FIG. 2A illustrates exemplary raw data pulled from a remote data storage system by the RDP of the data storage management system of FIG. 1.

FIG. 2B illustrates an exemplary standard format into which data from a remote site has been converted into via the RDP, according to embodiments of the present invention.

FIG. 2C illustrates an exemplary format of data stored in the mediation database.

FIG. 3 sets forth a non-exhaustive list of possible system faults at a remote site.

FIGS. 4A-4C are exemplary web portal user interfaces, according to embodiments of the present invention.

FIG. 5 is a block diagram that illustrates methods of managing remotely located data storage systems, according to embodiments of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The terms “remotely located data storage system”, “remote data storage system”, “storage system”, “customer data storage system”, “customer site” are interchangeable and, as used herein, refer to any customer site where data is stored electronically, in stand-alone data storage devices, networked or otherwise connected data storage devices, any intelligent device in any static or mobile location, including but not limited to, corporate offices, internet data centers, distributed systems, centralized systems, branch offices, mobile users, enterprise locations, consumers, etc.

The terms “data storage management” and “storage management” are interchangeable and, as used herein, refer to any type of data storage service including, but not limited to, data backup and recovery, primary data storage, data archiving, business continuity and disaster recovery, and remote data storage management.

The term “agent”, as used herein, refers to a network-based program (or programs) that gathers information and/or performs some service, typically according to a schedule and without requiring a user's presence.

As used herein, the term “and/or” includes any and all combinations of one or more of the associated listed items.

The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. However, software embodiments of the present invention do not depend on implementation with a particular programming language. It will be further appreciated that the functionality of any or all of the program modules may also be implemented using discrete hardware components, one or more application specific integrated circuits (ASICs), or a programmed digital signal processor or microcontroller.

The present invention is described below with reference to block diagram and flowchart illustrations of methods, apparatus (systems) and computer program products according to embodiments of the invention. It will be understood that each block of the block diagrams and/or flowchart illustrations, and combinations of blocks, can be implemented by computer program instructions and/or hardware operations. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process or method such that the instructions which execute on the computer or other programmable apparatus provide steps for implementing the functions specified in the block diagram and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

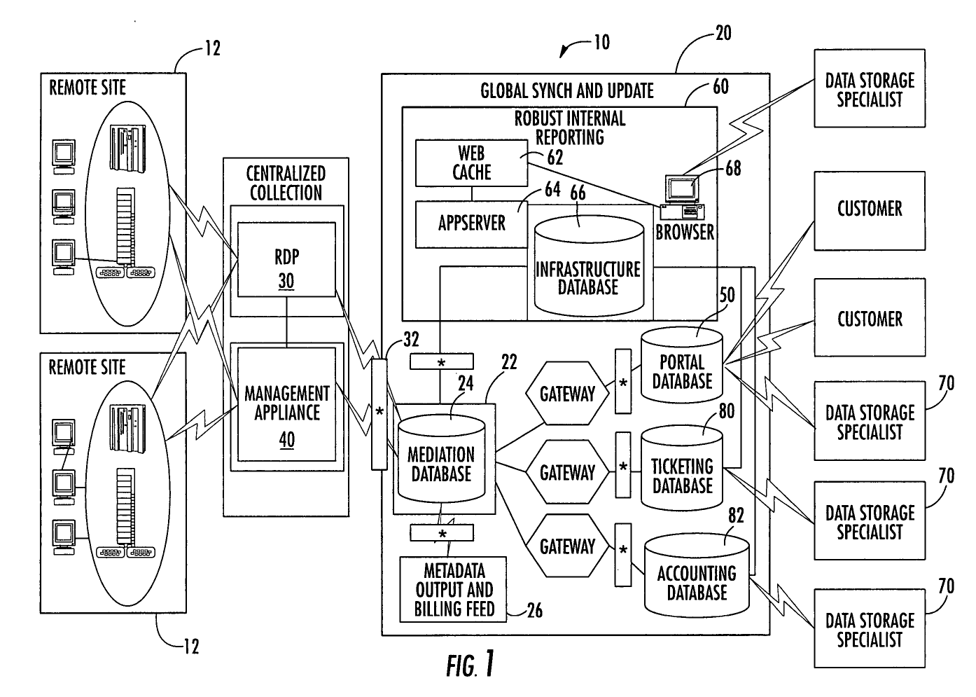

Referring initially to FIG. 1, an agent-less data storage management system 10 for managing a plurality of remotely located customer data storage systems 12, according to embodiments of the present invention, is illustrated. The terms “remotely located customer data storage systems”, “remote site” and “data storage systems”, as used herein, are intended to be interchangeable. The term “agent-less” means that a data storage management system 10, and all of its various components according to embodiments of the present invention, performs all of its functions without requiring the use of agents or any other software or equipment at a remote data storage site 12. A data storage management system 10, according to embodiments of the present invention, is capable of communicating directly with devices at each remote site 12, obtaining metadata directly from these devices, and implementing corrective actions at each remote site 12 without the use of agents.

The illustrated agent-less data storage management system 10 allows multiple independent customers to efficiently utilize the knowledge, skills, and services of a shared pool of data storage experts without relinquishing control of their respective data storage systems. Embodiments of the present invention can result in higher quality of service and lower management costs than any one customer could achieve on their own.

The illustrated agent-less data storage management system 10 utilizes a combination of distributed intelligent networks, human expertise, and automated systems to manage multiple third party data storage systems. A staff of storage specialists monitor data feeds and system status information originating from the various remote data storage systems 12. When system faults occur, the central staff initiates corrective action to clear the faults and maintain systems operations. In addition, the information collected from the various data storage systems is analyzed for recognizable patterns that precede and can indicate developing fault situations at the remote data storage systems 12. These patterns are then programmed into the data storage management system 10 to trigger predictive alarms that enable the central staff to take preemptive measures necessary to avoid disruptions in service. Customers can access information regarding their specific data storage systems 12 and request changes and services through a respective web portal that utilizes an individually customized interface and appearance of a dedicated management system.

The illustrated agent-less data storage management system 10 includes a control center 20 having a central data repository 22, a raw data processor (RDP) 30, a management appliance 40, a plurality of web portals implemented by a portal database 50, and a data mining and reporting system 60. Each of these components of the agent-less data storage management system 10 is described below.

RDP

The RDP 30 may include one or more processors executing code to perform the various RDP functions described herein. The RDP 20 collects raw, unformatted metadata directly from each respective remote data storage system 12, transforms the collected metadata to a standardized format, and then stores the transformed metadata in the central data repository 22. The RDP 20 communicates with, and collects metadata from, each remote data storage system 12 without the use of agents. A configuration file(s) identifies remote sites 12, technologies, access methods and frequencies to pull raw unformatted metadata. The configuration file instructs the RDP 30 as to which remote data storage system the RDP 30 is to obtain raw, unformatted metadata from. In addition, the configuration file identifies the data storage technologies at a remote site, what access methods are to be utilized by the RDP 30 and what frequency the RDP 30 is to pull raw, unformatted metadata from a remote site 12.

According to embodiments of the present invention, the RDP 30 is configured to communicate and pull metadata from remote sites 12 on a continuous basis for selected activities and on an ad hoc basis for other activities. For example, metadata associated with system changes at a remote site (e.g., a controller malfunction, loss of a power supply, etc.) are continuously pulled by the RDP 30. Metadata associated with ad hoc events (e.g., whether firmware update implemented at a remote site) are pulled by the RDP 30 on an as needed basis. Metadata may also be pulled from a remote site on a scheduled basis (e.g., remote system configuration checks, etc.) by the RDP 30.

The RDP 30 is configured to pull metadata from any of various data storage equipment technologies and data storage software technologies. For example, the RDP 30 is configured to pull metadata from disk drives, tape drives, etc. The RDP 30 is also configured to pull metadata from any software technologies, such as VERITAS™ data backup and recovery software.

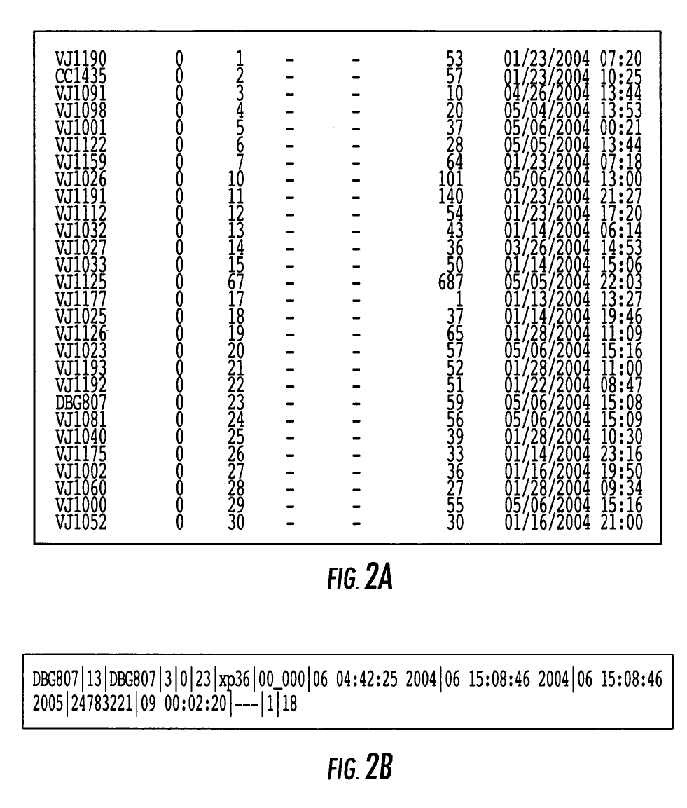

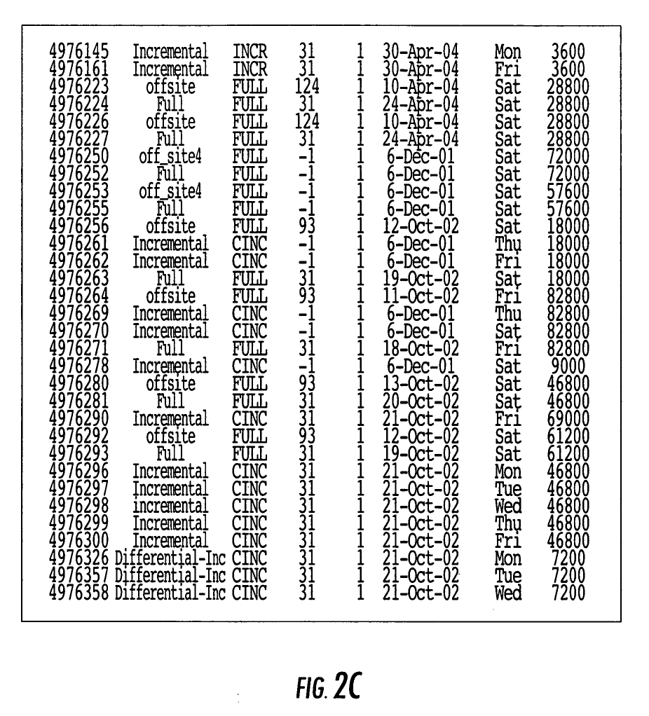

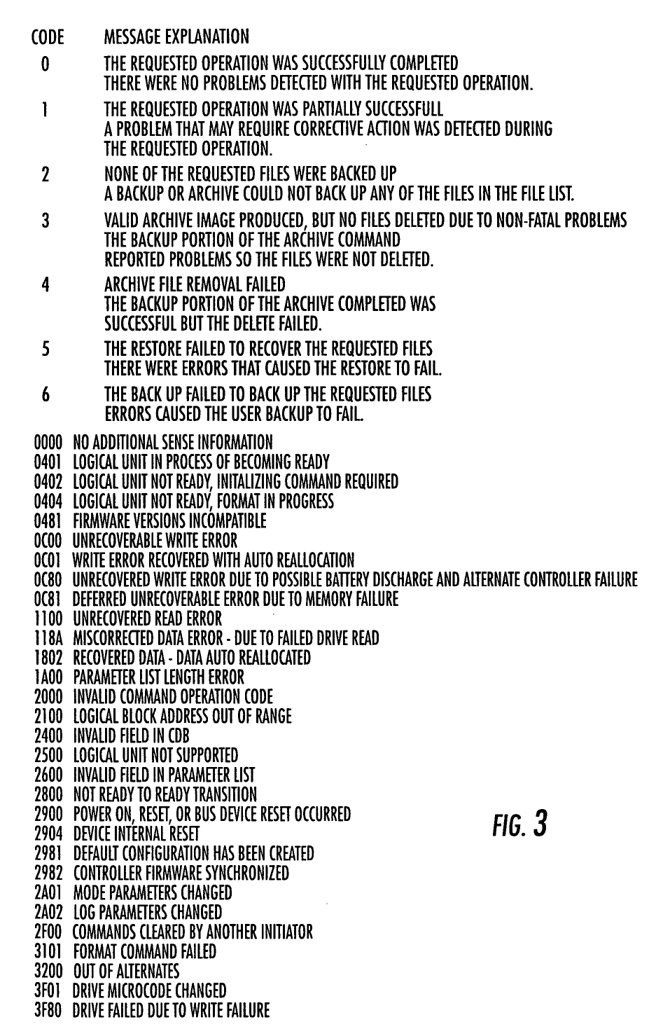

FIG. 2A illustrates exemplary raw data pulled from a remote data storage system 12 by the RDP 30. FIG. 2B illustrates an exemplary standard format into which data from a remote site 12 has been converted into via the RDP 30, according to embodiments of the present invention.

According to embodiments of the present invention, the RDP 30 archives collected metadata prior to transforming the collected metadata to a standardized format. Accordingly, raw, unformatted metadata is available for later use if necessary. In addition, in order to reduce the amount of metadata stored in the central data repository 22, the RDP 30 may consolidate and/or filter collected metadata prior to transforming, archiving and/or storing the collected metadata in the central data repository 22. The configuration file(s) may define what functions are performed by the RDP at a particular remote data storage system 12.

The sources for metadata (e.g., sources for performance and operational information) at a remote data storage system 12 may be numerous and may be in a constant state of flux. Data storage devices at a remote site 12 may include, but are not limited to: individual drives; cabinet controller boards; network communication switches; host bus adaptors; routers; patch panels; power sources; server hardware; operating systems; and application software. Metadata pulled from data storage devices at a remote site 12 may be “in band” (i.e., the management control path follows the same path as the data path) and/or “out of band” (i.e., the management control path is separated from the data path) and may include, but is not limited to: internal ASCII data logs, SNMP available management information base (MIB) instrumentation, configuration data available from console ports, device and application instrumentation, and software API (application programming interface) accessible status. As known to those skilled in the art, a MIB creates a metadata definition to translate machine conditions to a text-readable format. Each of these components may be from a different vendor. As such, troubleshooting these systems via conventional methods can be highly complex and labor intensive, requiring a skilled and knowledgeable technician with physical access to the various pieces of equipment. The technician conventionally is required to manually access and extract the information and make informed judgment calls as to the root cause of identified problems, and what information to retrieve.

Of the various conventional data storage management tools on the market today, no one management tool collects and analyzes multiple types of information as discussed above. For example network management tools will only collect SNMP data, while other tools are monolithic in structure and focus only on a single function such as back-up management. No single conventional tool takes an overall system approach as do embodiments of the present invention.

The devices at a remote site 12 that the RDP 30 collects data from are typically heterogeneous (i.e., the devices are from different vendors and utilize different protocols, etc.), may use different proprietary data formats, and may be incompatible with each other.

The RDP 30, according to embodiments of the present invention, provides a single point of contact for multiple independent information sources at a remote site 12. Using policies, scripts, and current status of the environment, metadata from a remote site 12 is consolidated, filtered, converted into a standardized format, and then stored at the central data repository 22 by the RDP 30 using secure communications technologies (e.g., secured sockets layer, etc.). These policies and scripts may embody a level of intelligent decision making that allows the filtering and formatting processes to be dynamic and dependent upon recent system events and current system status. This intelligent dynamic processing serves to assure only appropriate and desired information about activities, performance and system health is pulled by the RDP 30 and communicated to the central data repository 22, thereby optimizing bandwidth utilization while minimizing processing load at the central data repository 22. This reduction in data load serves to expand overall system scalability and efficiency.

The capability of the configuration file to determine which information needs to be filtered allows for automatic and dynamic adjustment of data reporting based on current status and events. The algorithms contained in these scripts, policies, and processing software may continually evolve over time based on the collective experience and knowledge gained from managing numerous heterogeneous data storage systems across diverse environments.

The RDP 30 transforms collected, unformatted raw metadata using a technology-agnostic interface 32 that is configured to create a consistent formatted metadata structure. The interface 32 is dynamically configurable and allows a user to expand (and reduce) the number and definition of fields in a formatted metadata structure over time. This is advantageous compared with conventional data storage management systems because the dynamic interface 32 allows new formatted metadata interface definitions to be applied to historic raw metadata. Conventional data storage management systems allow revised metadata structures to apply to only metadata collected after the metadata structure is changed, not to historic metadata.

As an example, a “Tape Label ID” is collected as raw metadata from a remote site 12 by the RDP 30, but is not currently used in up-stream processing capabilities. Therefore, Tape Label ID's are archived prior to transformation of other raw metadata and storage at the central data repository 22. At a future time, it is decided to create a web portal report using the stored Tape Label ID. The interface 32 is modified and the archived metadata are processed by the RDP 30. The newly transformed historically accurate metadata is loaded into the central repository 22 and is available to the web portal to provide on-going reports on this new aspect of metadata.

According to embodiments of the present invention, the RDP 30 includes problem identification logic that is configured to review metadata as it is collected and identify problems at a remote data storage system that require resolution. The problem identification logic may be configured to identify data patterns known to precede data storage problems at a respective remotely located data storage system. The identification of a problem can trigger various courses of remedial action including anything from the generation of an alarm to dynamic changes in the reporting and recording of details at a customer site 12.

Management Appliance

The management appliance 40 may include one or more processors executing code to perform the various management appliance functions described herein. The management appliance 40 is configured to implement corrective actions and configuration changes at each remote data storage system 12 without the use of agents at the remote data storage system 12. Corrective actions and configuration changes may be implemented by a user (e.g., a data storage specialist, or a customer) monitoring the data storage management system 10 via a web portal implemented by the portal database 50. Corrective actions and configuration changes may also be implemented in response to the identification of a problem at a remote data storage system via problem identification logic associated with the management appliance 40.

An exemplary management appliance 40 function includes setting up new servers on a backup service at a remote site 12. For example, a remote customer requests to update server information via a web portal implemented by the portal database 50. If the request can be performed without the assistance of a storage administrator, the appropriate commands are created and sent to the remote site for activation via the management appliance 40. If the request requires human intervention, it is routed through a ticketing system implemented by the ticketing database 80 to the appropriate skill level administrator. An exemplary ticketing system is described in co-pending and commonly-owned U.S. patent application Ser. No. 10/784,605, filed Feb. 23, 2004, which is incorporated herein by reference in its entirety.

In addition, major remote site changes, such as application patches can be distributed via the management appliance 40 to multiple remote sites 12 requiring updates, rather than the traditional approach of on-site patching on a “site-by-site” basis.

Control Center

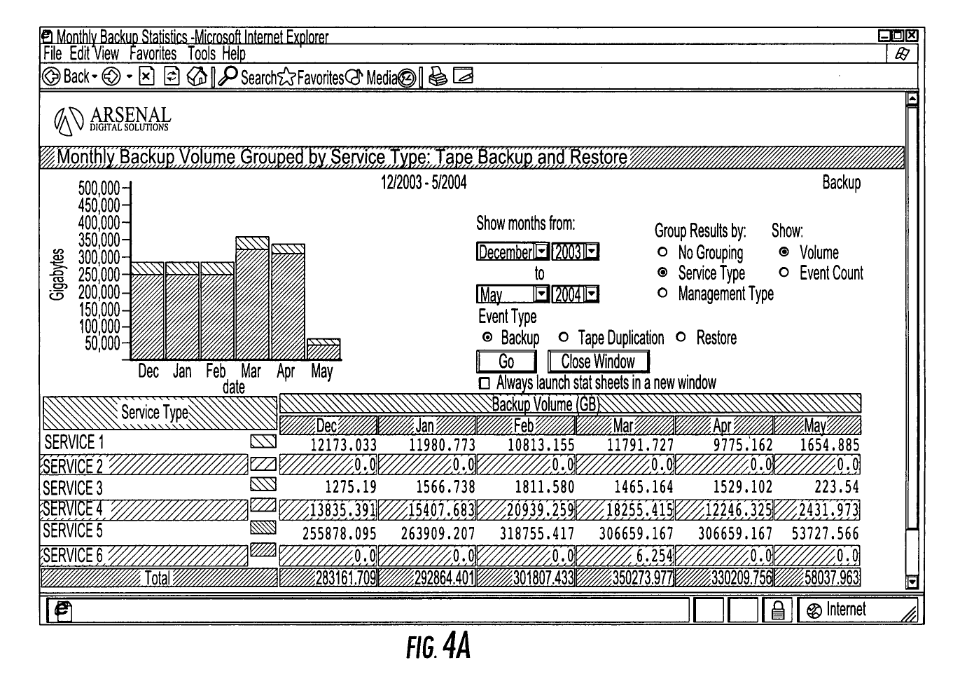

The illustrated control center 20 includes the central data repository 22, portal database 50, a data mining and reporting system 60, ticketing database 80, and accounting database 82. The central data repository 22, according to embodiments of the present invention, receives and processes remote site data collected and transformed by the RDP 30. Depending on the type of metadata received at the central data repository 22, the metadata is either stored in a mediation database 24 or, in the case of an identified system fault at a remote site 12, converted to an alert. FIG. 2C illustrates an exemplary format of data stored in the mediation database 24. System faults at a remote site 12 may include hardware problems, component problems, device level problems, application problems, and networking issues, and can span the full range of all systems that encompass service delivery. Identified system faults are aggregated, correlated and filtered by the mediation database 24 to provide unique, actionable support issues. These actionable faults are logged, displayed in human-readable presentation formats and automatically integrated in an automated ticketing system implemented by the ticketing database 80. Once these faults are in the automated ticketing system, they are classified according to priority, customer, location, level of support personnel, and required resolution path. FIG. 3 sets forth a non-exhaustive list of possible system faults at a remote site 12.

According to embodiments of the present invention, when a system fault occurs, alerts are immediately communicated by the mediation database 24 and viewable to a data storage specialist 70 at the control center 20 via a web portal implemented by the portal database 50. The data storage specialist 70 can review the system fault information via a web portal and take action, if necessary, via the web portal. Communication between the control center 20 and data storage specialists 70 can be via e-mail, display, printed log, pager and/or other means known to those skilled in the art. A data storage specialist 70 may respond to an event by requesting additional information required, and initiating appropriate intervention measures. The mediation database 24 monitors when each event is reported, when each event is acknowledged by a data storage specialist 70, what action is initiated, and when the fault was closed (e.g., when a fault condition is rectified at a remote site 12).

According to embodiments of the present invention, the mediation database 24 may use historical trend and configuration data to go beyond identification of current system faults by using pattern recognition and artificial intelligence to identify emerging problems at a remote site 12. This allows a data storage specialist 70 to proactively initiate preventative measures. Utilizing the mediation database 24, ticketing database 80, accounting database 82, and portal database 50, inbound data is processed to identify patterns of activities and events that are known to indicate developing system issues. These databases act as a logical metadata storage repository for the on-going input of metadata. These databases may be implemented via one or more commercial and/or custom database package.

The central data repository 22 is a consolidation point acting across multiple technologies and geographic locations. As metadata is loaded into the mediation database 24, there is an archiving effect supporting the multi-generational history of metadata, across service technologies and physical locations. This allows root causes to be quickly isolated and resolved before system performance problems can impact business operations of a customer. Pattern recognition algorithms and identified patterns are constantly being refined and revised by the mediation database 24 (as well as by the RDP 30 and management appliance 40) to reflect new equipment, configurations, and experience gained from the ongoing management of a population of diverse remote storage system configurations.

The present invention is advantageous because the mediation database 24 allows for a small number of data storage specialists 70 to easily manage a large number of remote customer data storage systems 12. Whenever intervention is required, a data storage specialist 70 at the control center 20 is alerted to initiate appropriate interventions. The course of action may range from automatic correction, to dispatching instructions to an on-site technician at a customer's data storage system 12, or a simple notification to the customer's own internal support staff. The selected course of action may be policy based and driven by the individual desires and agreement with each customer.

The control center 20 can be utilized to provide quality assurance monitoring when hands-on intervention is required at a customer site to, for example, change a cable, replace a board, or manually adjust or replace some other piece of equipment. While a variety of techniques may be employed, they can be combined to allow a less skilled third party provide the required service without clouding the issues of overall responsibility or liability for system performance. According to embodiments of the present invention, the control center 20 automatically issues an activity dispatch when intervention is required, and closes the ticket when action is verified to have been completed. During this activity window, a customer's data storage system 12 is monitored for the expected patterns of messages and alerts as the required work is performed.

According to embodiments of the present invention, additional levels of supervision can be employed through the use of real time audio and video monitoring, as well as the use of step by step scripted directives issued by a specialist at the control center 20. An example includes the use of video and voice over IP to a handheld PDA equipped with a Web camera and wireless LAN card. Communication can occur over an established network infrastructure and step by step commands can be given from the control center 20. Real time audio and video feedback from the handheld PDA camera allows a data storage specialist 70 at the control center 20 to verify that the work is being performed correctly by a technician at the remote site 12.

According to embodiments of the present invention, preemptive measures can be taken by the control center 20 in response to identifying data patterns that indicate potential problems at a customer's data storage system 12. Broad categories include hardware, software, network which are further broken down by platform and device, type of software package and topology. For example, if a system backup at a customer's data storage system 12 fails, an automated response from the control center 20 can automatically restart the backup. If the backup fails again, an error code can be assigned. The failure is then correlated and presented to a central alerting system at the control center 20 where it is classified and prioritized and is visible to a human support staff, as well as automatically updated, depending on severity, to a ticketing system. If corrective action is not taken within a defined time period, the issue may be automatically escalated thru a parallel escalation scheme of technical support personnel and other contacts.

Web Portals

Each web portal implemented by the portal database 50 is associated with a respective one of the customer data storage systems 12 via the mediation database 24. Each web portal provides customer access to information about a remote data storage system 12 in graphical and report-based formats, and allows customer control and configuration of the data storage system 12. In addition, each web portal provides data storage specialist 70 access to the various remote data storage systems 12. According to embodiments of the present invention, each web portal provides users (i.e., customers and data storage specialists) with web-based access to system performance information and status, and can be used to request services and make system changes. Customized to the desires and needs of each individual user, the data storage management system 10 appears to the user, via a web portal, as a dedicated private storage management service. Each web portal can provide users with reports by month, week, or day for disk allocation, backup size, and restore size. Each web portal also provides user access to total and average daily volume and usage, and to total volume by location by server. Each web portal can be utilized to retrieve metrics on any location, server, or volume; view historical usage to understand future costs; and view alerts and messages on system status.

Each web portal implemented by the portal database 50 is integrated with the RDP 30, management appliance 40, central data repository 22 and billing system. This results in a single interface that allows users to obtain timely information on all services offered by the data storage management system 10. Each web portal can be easily co-branded and seamlessly integrated into a user's own portal to improve visibility and simplify management.

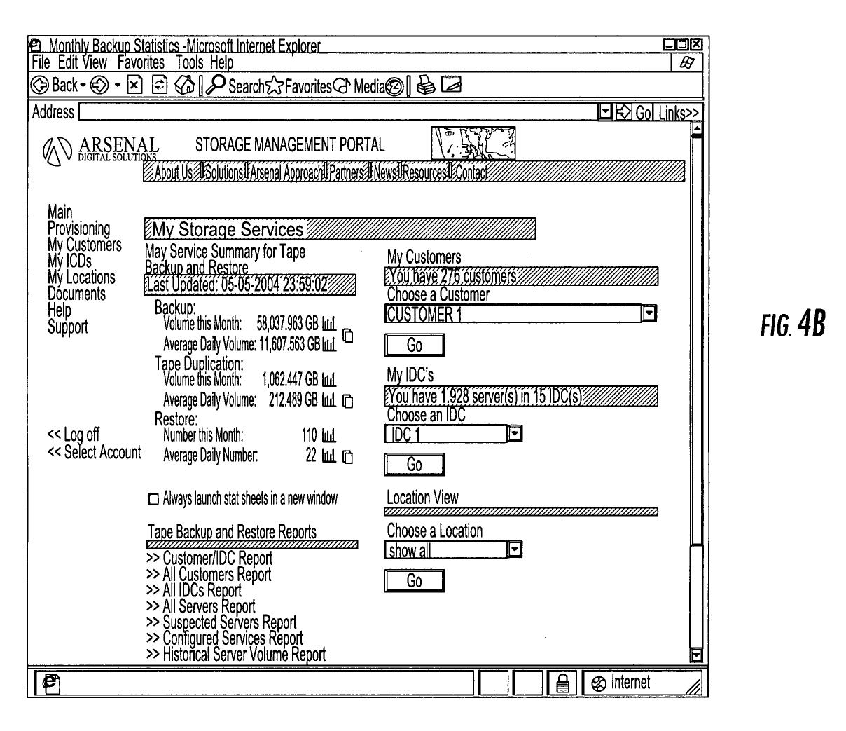

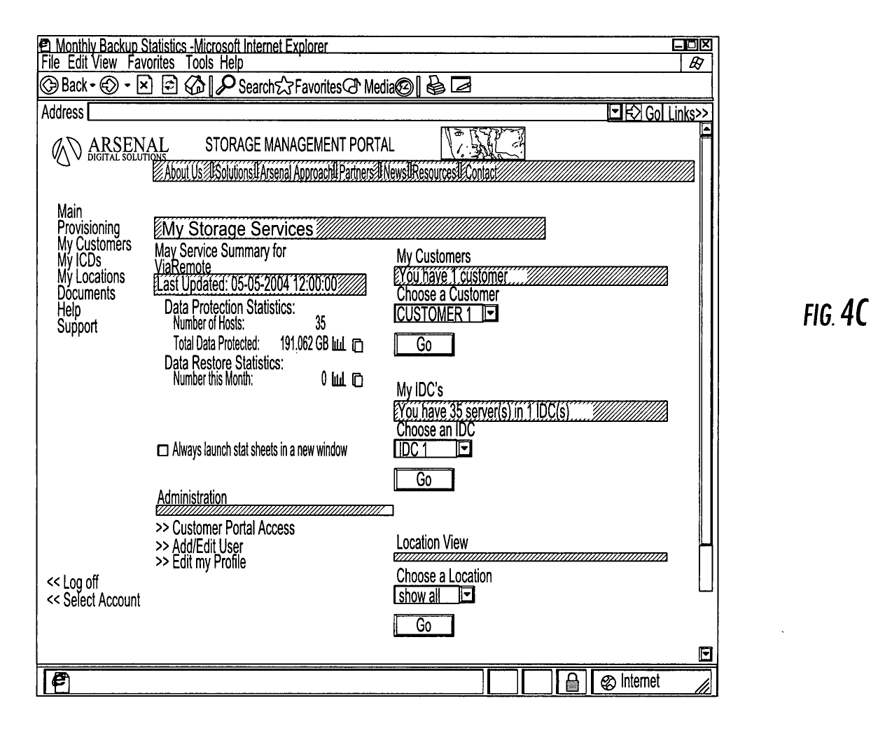

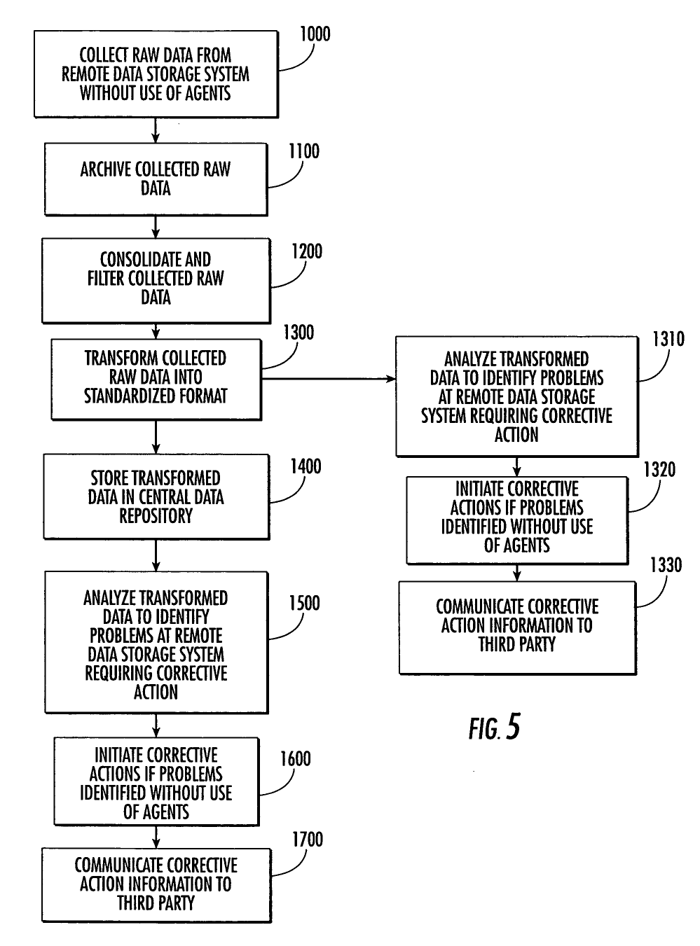

Exemplary web portal user interfaces are illustrated in FIGS. 4A-4C. FIG. 4A illustrates a user interface entitled Monthly Backup Volume Grouped By Service Type: Tape Backup and Restore. The illustrated user interface shows various service offerings/options and the historical data volume associated with them. A user can dynamically configure report views to different dates, service types, event types and groupings via the illustrated user interface. FIG. 4B illustrates a user interface entitled Main Storage Portal Page: Tape Backup and Restore. The illustrated user interface shows summary level information for multiple services and abstracts information across a plurality of remote sites, customers and technologies. A user can “drill-down” into specific reports, configurations, locations, groupings, etc. FIG. 4C illustrates a user interface entitled Main Storage Portal Page: Remote Backup Service. The illustrated user interface shows summary level info for remote backup service and abstracts information across a plurality of remote sites, customers and technologies. A user can “drill-down” into specific reports, configurations, locations, groupings, etc. FIGS. 4A-4C are only a few of the many user interfaces that can be utilized.

Data Mining and Reporting

Referring back to FIG. 1, embodiments of the present invention include a data mining and reporting system 60 configured to mine metadata stored in the central data repository 22 and to prepare reports utilizing mined data. The illustrated data mining and reporting system 60 includes a web cache 62, an appserver 64, and an infrastructure database 66. A user performs data mining and reporting via a browser 68. The web cache 62 serves the function of supplemental “processing power” for complex query and search algorithms associated with data mining. The appserver 64 is the main user interface for web cache 62. The infrastructure database 66 is where parts of metadata are stored for access. When a user makes a data mining query request, the request first goes to the appserver 64, then gets calculated by the web cache 62 and follows a logical view to one or more databases to access the metadata. The resulting metadata report is then presented to the user via a browser 68.

Metadata Output and Billing Feed

Referring back to FIG. 1, embodiments of the present invention include a metadata output and billing feed 26 associated with the mediation database 24. According to embodiments of the present invention, metadata output is an XML and CSV based output mechanism that can feed other web portals and applications. For example, because some customers may not have a web portal, these customers obtain “metadata output” from the mediation database 24 via the metadata output and billing feed 26. According to embodiments of the present invention, billing feed is an XML and CSV based output used to send a subset of metadata useful in billing and invoicing end customers. For example, some services bill by quantity used. The billing feed has the intelligence to know which customer metadata is which and how to calculate and present the metadata into one, consolidated bill, per partner. This “bill/invoice” is delivered electronically to a user by the “billing feed” mechanism and then moves into the accounting database 82 as an accounts receivable invoice. Billing of unique usage-based storage events, irrespective of the service being provided, can be obtained via embodiments of the present invention.

Referring to FIG. 5, methods of managing remotely located data storage systems, according to embodiments of the present invention, are illustrated. Raw, unformatted data (i.e., metadata) is collected directly from a remote data storage system without the use of an agent executing at the remote data storage system (Block 1000). Collected raw metadata may be archived (Block 1100) and may be consolidated and/or filtered (Block 1200). The collected raw metadata is then transformed into a standardized format (Block 1300) and stored in a central data repository (Block 1400).

The transformed collected metadata may be analyzed to identify problems at a remote data storage system that requires corrective action (Block 1310) prior to storing the transformed metadata in a central data repository. For example, the transformed collected metadata may be analyzed to identify data patterns that are known to precede fault conditions. According to other embodiments of the present invention, the collected metadata may be analyzed to identify problems at a remote data storage system prior to transformation to a standardized format. Corrective action may be initiated at a remote data storage system, without the use of an agent executing at the remote data storage system, if any problems are identified (Block 1320), either before or after transformation of the collected metadata. Initiated corrective actions may include communicating corrective action information to a third party (Block 1330).

Analysis of the transformed collected metadata may also take place after being stored in a central data repository, according to embodiments of the present invention. As illustrated in FIG. 5, the stored metadata may be analyzed to identify problems at a remote data storage system that requires corrective action (Block 1500). For example, the stored metadata may be analyzed to identify data patterns that are known to precede fault conditions. Corrective action may be initiated at a remote data storage system, without the use of an agent executing at the remote data storage system, if any problems are identified (Block 1600). Initiated corrective actions may include communicating corrective action information to a third party (Block 1700).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. An agent-less data storage management system, comprising:
a central data repository;
a raw data processor (RDP) that collects raw, unformatted metadata directly from each respective remote data storage system, transforms the collected metadata to a standardized format, and stores the transformed metadata in the central data repository, wherein the RDP is configured to collect metadata from each remote data storage system without the use of an agent executing at each remote data storage system;
a management appliance that implements corrective action and configuration changes at each data storage system, and makes configuration changes at each data storage system without the use of an agent executing at each remote data storage system; and
problem identification logic operably associated with the central data repository, RDP and management appliance, wherein the problem identification logic is configured to review metadata collected by the RDP, identify problems at remote data storage systems that require resolution, and initiate corrective action at a respective remote data storage system in response to identifying a problem.

2. The agent-less data storage management system of claim 1, wherein the RDP archives the collected metadata prior to transforming the collected metadata to a standardized format.

3. The agent-less data storage management system of claim 1, wherein the RDP consolidates the collected metadata prior to storing the collected metadata in the central data repository.

4. The agent-less data storage management system of claim 1, wherein the RDP filters collected metadata to reduce an amount of metadata stored in the central data repository.

5. The agent-less data storage management system of claim 1, wherein the RDP comprises a dynamically modifiable interface for use in transforming raw, unformatted metadata to a standardized format.

6. The agent-less data storage management system of claim 1, wherein the problem identification logic is configured to initiate corrective action at a respective remote data storage system via the management appliance.

7. The agent-less data storage management system of claim 1, wherein the problem identification logic comprises pattern recognition logic that is configured to identify patterns known to precede data storage problems at a respective remotely located data storage system.

8. The agent-less data storage management system of claim 1, wherein each remotely located data storage system comprises one or more data storage devices.

9. The agent-less data storage management system of claim 8, wherein the one or more data storage devices comprise heterogeneous data storage devices.

10. The agent-less data storage management system of claim 1, further comprising a plurality of portals, each portal associated with a respective one of the remotely located data storage systems and each portal in communication with the central data repository, wherein each portal provides user access to information about a respective one of the remotely located data storage systems.

11. The agent-less data storage management system of claim 10, wherein each portal allows user control and configuration of data storage devices at a remotely located data storage system.

12. The agent-less data storage management system of claim 1, further comprising a data mining and reporting system configured to mine metadata stored in the central data repository and to prepare reports utilizing mined data.

13. An agent-less data storage management system, comprising:
a central data repository;
a raw data processor (RDP) that collects raw, unformatted metadata directly from each respective remote data storage system, archives the collected metadata, transforms the collected metadata to a standardized format, and stores the transformed metadata in the central data repository, wherein the RDP is configured to collect metadata from each remote data storage system without the use of an agent executing at each remote data storage system, and wherein the RDP is configured to collect metadata from a plurality of heterogeneous devices, and wherein the RDP comprises a dynamically modifiable interface for use in transforming raw, unformatted metadata to a standardized format;
a management appliance that implements corrective action and configuration changes at each data storage system, and makes configuration changes at each data storage system without the use of an agent executing at each remote data storage system; and
problem identification logic operably associated with the central data repository, RDP and management appliance, wherein the problem identification logic is configured to review metadata collected by the RDP, identify problems at remote data storage systems that require resolution, and initiate corrective action at a respective remote data storage system in response to identifying a problem.

14. The agent-less data storage management system of claim 13, wherein the problem identification logic is configured to initiate corrective action at a respective remote data storage system via the management appliance.

15. The agent-less data storage management system of claim 13, wherein the problem identification logic comprises pattern recognition logic that is configured to identify patterns known to precede data storage problems at a respective remotely located data storage system.

16. The agent-less data storage management system of claim 13, further comprising a plurality of portals, each portal associated with a respective one of the remotely located data storage systems and each portal in communication with the central data repository, wherein each portal provides user access to information about a respective one of the remotely located data storage systems, and wherein each portal allows user control and configuration of data storage devices at a remotely located data storage system.

17. The agent-less data storage management system of claim 13, further comprising a data mining and reporting system configured to mine metadata stored in the central data repository and to prepare reports utilizing mined data.

18. An agent-less data storage management system, comprising:
a central data repository;
a raw data processor (RDP) that collects raw, unformatted metadata directly from each respective remote data storage system, transforms the collected metadata to a standardized format, and stores the transformed metadata in the central data repository, wherein the RDP is configured to collect metadata from each remote data storage system without the use of an agent executing at each remote data storage system, and wherein the RDP is configured to collect metadata from a plurality of heterogeneous devices;
a management appliance that implements corrective action and configuration changes at each data storage system, and makes configuration changes at each data storage system without the use of an agent executing at each remote data storage system;
problem identification logic operably associated with the central data repository, RDP and management appliance, wherein the problem identification logic is configured to review metadata collected by the RDP, identify problems at remote data storage systems that require resolution, and initiate corrective action at a respective remote data storage system in response to identifying a problem;
a plurality of portals, each portal associated with a respective one of the remotely located data storage systems and each portal in communication with the central data repository, wherein each portal provides user access to information about a respective one of the remotely located data storage systems; and
a data mining and reporting system configured to mine metadata stored in the central data repository and to prepare reports utilizing mined data.

19. The agent-less data storage management system of claim 18, wherein the problem identification logic is configured to initiate corrective action at a respective remote data storage system via the management appliance.

20. The agent-less data storage management system of claim 18, wherein the problem identification logic comprises pattern recognition logic that is configured to identify patterns known to precede data storage problems at a respective remotely located data storage system.

21. An agent-less data storage management system, comprising:
a central data repository;
a raw data processor (RDP) that collects raw, unformatted metadata directly from each respective remote data storage system, archives the collected metadata, transforms the collected metadata to a standardized format, and stores the transformed metadata in the central data repository, wherein the RDP is configured to collect metadata from each remote data storage system without the use of an agent executing at each remote data storage system, and wherein the RDP is configured to collect metadata from a plurality of heterogeneous devices;
a management appliance that implements corrective action and configuration changes at each data storage system, and makes configuration changes at each data storage system without the use of an agent executing at each remote data storage system;
problem identification logic operably associated with the central data repository, RDP and management appliance, wherein the problem identification logic is configured to review metadata collected by the RDP, identify problems at remote data storage systems that require resolution, and initiate corrective action at a respective remote data storage system in response to identifying a problem, wherein the problem identification logic comprises pattern recognition logic that is configured to identify patterns known to precede data storage problems at a respective remotely located data storage system; and
a plurality of portals, each portal associated with a respective one of the remotely located data storage systems and each portal in communication with the central data repository, wherein each portal provides user access to information about a respective one of the remotely located data storage systems.

22. The agent-less data storage management system of claim 21, wherein the problem identification logic is configured to initiate corrective action at a respective remote data storage system via the management appliance.

23. The agent-less data storage management system of claim 21, further comprising a data mining and reporting system configured to mine metadata stored in the central data repository and to prepare reports utilizing mined data.

24. A method of managing a remotely located data storage system, comprising:
collecting raw, unformatted metadata directly from a remote data storage system without the use of an agent executing at the remote data storage system;
transforming the collected metadata to a standardized format;
storing the transformed metadata in a central data repository; and
analyzing the collected metadata to identify problems at the remotely located data storage system requiring corrective action.

25. The method of claim 24, further comprising implementing corrective action at the data storage system responsive to identifying a problem, and wherein the corrective action is implemented without the use of an agent executing at the remote data storage system.

26. The method of claim 24, wherein analyzing the collected metadata to identify problems at the remotely located data storage system comprises identifying data patterns that precede fault conditions.

27. The method of claim 24, further comprising archiving the collected metadata prior to transforming the collected metadata to a standardized format.

28. The method of claim 24, further comprising consolidating the collected metadata prior to storing the collected metadata in the central data repository.

29. The method of claim 24, further comprising communicating corrective action information to a third party for implementation at the remotely located data storage system in response to identifying data patterns that precede fault conditions at the remotely located data storage system.

30. The method of claim 24, further comprising filtering collected metadata prior to storing the collected metadata in the central data repository.

31. The method of claim 24, wherein the metadata comprises data and storage hardware information at the remotely located data storage system.

32. A method of managing a remotely located data storage system, comprising:
collecting raw, unformatted metadata directly from a remote data storage system without the use of an agent executing at the remote data storage system;
transforming the collected metadata to a standardized format;
storing the transformed metadata in a central data repository;
analyzing the collected metadata to identify problems at the remotely located data storage system requiring corrective action, comprising identifying data patterns that precede fault conditions; and
implementing corrective action at the data storage system responsive to identifying a problem, wherein the corrective action is implemented without the use of an agent executing at the remote data storage system.

33. The method of claim 32, further comprising archiving the collected metadata prior to transforming the collected metadata to a standardized format.

34. The method of claim 32, further comprising consolidating the collected metadata prior to storing the collected metadata in the central data repository.

35. The method of claim 32, further comprising communicating corrective action information to a third party for implementation at the remotely located data storage system in response to identifying data patterns that precede fault conditions at the remotely located data storage system.

36. The method of claim 32, further comprising filtering collected metadata prior to storing the collected metadata in the central data repository.

37. The method of claim 32, wherein the metadata comprises data and storage hardware information at the remotely located data storage system.

38. A computer program product for managing a remotely located data storage system, the computer program product comprising a computer usable storage medium having computer readable program code embodied in the medium, the computer readable program code comprising:
computer readable program code that collects raw, unformatted metadata directly from a remote data storage system without the use of an agent executing at the remote data storage system;
computer readable program code that transforms the collected metadata to a standardized format;
computer readable program code that stores the transformed metadata in a central data repository; and
computer readable program code that analyzes the collected metadata to identify problems at the remotely located data storage system requiring corrective action.

39. The computer program product of claim 38, further comprising computer readable program code that implements corrective action at the data storage system responsive to identifying a problem, and wherein the corrective action is implemented without the use of an agent executing at the remote data storage system.

40. The computer program product of claim 38, wherein the computer readable program code that analyzes the collected metadata to identify problems at the remotely located data storage system comprises computer readable program code that identifies data patterns that precede fault conditions.

41. The computer program product of claim 38, further comprising computer readable program code that archives the collected metadata prior to transforming the collected metadata to a standardized format.

42. The computer program product of claim 38, further comprising computer readable program code that consolidates the collected metadata prior to storing the collected metadata in the central data repository.

43. The computer program product of claim 38, further comprising computer readable program code that communicates corrective action information to a third party for implementation at the remotely located data storage system in response to identifying data patterns that precede fault conditions at the remotely located data storage system.

44. The computer program product of claim 38, further comprising computer readable program code that filters collected metadata prior to storing the collected metadata in the central data repository.

45. The computer program product of claim 1, wherein the metadata comprises data and storage hardware information at the remotely located data storage system.

46. A computer program product for managing a remotely located data storage system, the computer program product comprising a computer usable storage medium having computer readable program code embodied in the medium, the computer readable program code comprising:
computer readable program code that collects raw, unformatted metadata directly from a remote data storage system without the use of an agent executing at the remote data storage system;
computer readable program code that transforms the collected metadata to a standardized format;
computer readable program code that stores the transformed metadata in a central data repository;
computer readable program code that analyzes the collected metadata to identify problems at the remotely located data storage system requiring corrective action, comprising computer readable program code that identifies data patterns that precede fault conditions; and
computer readable program code that implements corrective action at the data storage system responsive to identifying a problem, wherein the corrective action is implemented without the use of an agent executing at the remote data storage system.

47. The computer program product of claim 46, further comprising computer readable program code that archives the collected metadata prior to transforming the collected metadata to a standardized format.

48. The computer program product of claim 46, further comprising computer readable program code that consolidates the collected metadata prior to storing the collected metadata in the central data repository.

49. The computer program product of claim 46, further comprising computer readable program code that communicates corrective action information to a third party for implementation at the remotely located data storage system in response to identifying data patterns that precede fault conditions at the remotely located data storage system.

50. The computer program product of claim 46, further comprising computer readable program code that filters collected metadata prior to storing the collected metadata in the central data repository.
